(19) United States
(12) Patent Application Publication
(10) Pub. No.: US 2016/0155076 A1
(43) Pub. Date: Jun. 2, 2016

(54) METHOD AND APPARATUS FOR IMPROVING SERVICE PROVIDER MAINTENANCE

(71) Applicants: AT&T Intellectual Property I, LP, Atlanta, GA (US); AT&T Mobility II LLC, Atlanta, GA (US)

(72) Inventors: Jeremy Fix, Acworth, GA (US); George Goehring, Decatur, GA (US); Michael Lugo, Atlanta, GA (US)

(21) Appl. No.: 14/556,341

(22) Filed: Dec. 1, 2014

(51) Int. Cl. G06Q 10/06

(52) U.S. Cl. CPC G06Q 10/06393; G06Q 10/06395

(57) ABSTRACT

Aspects of the subject disclosure may include, for example, identifying, a configuration adjustment for generating a quality improvement for a first element of a network for providing communication services to a first customer premises according to a first model that includes a linear regression of configuration data and key performance indicators. A customer lifetime improvement can be calculated a according to the quality improvement, according to a second model that comprises a correlation of the key performance indicators and customer lifetime data that are associated with the plurality of customer premises. A configuration cost associated with the configuration adjustment of the first element can be determined. A dispatch server can be directed to perform the configuration adjustment of the first element responsive to determining that a lifetime improvement value exceeds a cost to configure value. Other embodiments are disclosed.

### FIELD OF THE DISCLOSURE

The subject disclosure relates to a method and apparatus for improving service provider maintenance.

### BACKGROUND

Customers can have varying requirements for an expected quality of service. Degradations in the quality of service can be identified by the customer, which then typically results in self-troubleshooting, calls to the service provider, and ultimately a dispatch by a technician to the customer premises. The amount of time that a customer spends engaging with service provider personnel and experiencing the quality issue can increase the likelihood of the customer obtaining service from a different provider and can reduce the customer's willingness to recommend the service to others. Improvements in service quality can enhance customer satisfaction and, in turn, improve customer loyalty.

### BRIEF DESCRIPTION OF THE DRAWINGS

Reference will now be made to the accompanying drawings, which are not necessarily drawn to scale, and wherein:

FIG. 1 depicts an illustrative embodiment of a system that manages maintenance of equipment used in providing communication services;

FIG. 2 depicts an illustrative embodiment of data flow in the system of FIG. 1;

FIG. 3 depicts an illustrative embodiment of a method used in portions of the system described in FIG. 1;

FIG. 4 depicts an illustrative embodiment of a communication system that provide media services and that enables proactive maintenance in providing those services;

FIG. 5 depicts an illustrative embodiment of a communication device; and

FIG. 6 is a diagrammatic representation of a machine in the form of a computer system within which a set of instructions, when executed, may cause the machine to perform any one or more of the methods described herein.

### DETAILED DESCRIPTION

The subject disclosure describes, among other things, illustrative embodiments for analyzing data associated with providing communication services to users and managing maintenance of equipment utilized in the providing of those communication services. Surveys can determine customer perceptions of the performance of a communication system of a service provider while providing communication services. Data from such surveys can identify key performance indicators, such as system accessibility, service call response times, or user equipment reliability, which can affect customer satisfaction with the performance of the service provider. Once the key performance indicators are identified, these indicators can be collected during the operation of communication system. Data that is associated with the configuration and maintenance of the equipment in the communication system can also be collected.

Predictive analytics can be applied to the collected key performance indicators and configuration data to determine how changes to the equipment configuration affect the key performance indicators and to provide a model to predict the key performance indicators in light of possible configuration changes. Analysis can be applied to correlate the key performance indicators with costs associated with customer care calls and dispatches of maintenance technicians to service customer complaints. Analysis can be applied to correlate the key performance indicators with data associated with customer churn or turnover. Various historical data, such as data associated with customer care, dispatch and maintenance, equipment counters and interconnection, and/or order information can be analyzed, such as via linear regression or other predictive analytic techniques, in conjunction with the key performance indicators to grade potential configuration changes. The exemplary embodiments can provide for a means to recommend and/or dispatch maintenance actions according to linear regression applied to the data.

One embodiment of the subject disclosure includes a server with a processor and a memory that stores executable instructions that, when executed by the processor, facilitate performance of operations, including applying linear regression to historic configuration data and historic key performance indicators to generate a first model. The historic configuration data can be associated with elements that provide communication services to a plurality of customer premises of a plurality of users over a network. The historic key performance indicators can be associated with the communication services of the plurality of customer premises. The server can correlate the historic key performance indicators and historic cost of maintenance data to determine a second model. The historic cost of maintenance data can be associated with the communication services of the plurality of customer premises. The server can determine, according to the first model, a configuration adjustment of a first element of the network for generating an improvement in first key performance indicators that are associated with first customer premises of the plurality of customer premises. The server can determine, according to the second model, a maintenance cost improvement according to the improvement in first key performance indicators. The maintenance cost improvement can be assigned a maintenance improvement value. The server can determine a configuration cost associated with the configuration adjustment of the first element, where the configuration cost can be assigned a cost to configure value. The server can determine whether the maintenance improvement value exceeds the cost to configure value and, in turn, transmit a recommendation for performing the configuration adjustment of the first element to a dispatch server responsive to determining that the maintenance improvement value exceeds the cost to configure value.

One embodiment of the subject disclosure includes a machine-readable storage device, comprising executable instructions that, when executed by a processor, facilitate performance of operations, including applying linear regression to configuration data and key performance indicators that are associated with providing communication services to a plurality of customer premises via a network to generate a first model. The processor can correlate the key performance indicators and customer lifetime data that are associated with the plurality of customer premises to determine a second model and can identify, according to the first model, a configuration adjustment of a first element of the network for generating a quality improvement that is associated with a first customer premises of the plurality of customer premises. The processor can calculate, according to the second model, a customer lifetime improvement according to the quality improvement and, in turn, the customer lifetime improvement can be assigned a lifetime improvement value. The processor can determine a configuration cost associated with the configuration adjustment of the first element and, in turn, the configuration cost can be assigned a cost to configure value. The processor can determine whether the lifetime improvement value exceeds the cost to configure value and, in turn, can direct a dispatch server to perform the configuration adjustment of the first element responsive to determining that the lifetime improvement value exceeds the cost to configure value.

One embodiment of the subject disclosure is a method that includes identifying, by a system comprising a processor according to a first model, a configuration adjustment for a first element of a network for providing communication services to a first customer premises. The configuration adjustment can generate a quality improvement that is associated with the first customer premises. The first model can comprise a linear regression of configuration data that is associated with providing the communication services to a plurality of customer premises and key performance indicators that are associated with the plurality of customer premises. The method can include calculating, by the system according to a second model, a customer lifetime improvement according to the quality improvement. The second model can comprise a correlation of the key performance indicators and customer lifetime data that are associated with the plurality of customer premises, and, in turn, the customer lifetime improvement can be assigned a lifetime improvement value. The method can include determining, by the system, a configuration cost associated with the configuration adjustment of the first element, and, in turn, the configuration cost can be assigned a cost to configure value. The method can include directing, by the system, a dispatch server to perform the configuration adjustment of the first element responsive to determining that the lifetime improvement value exceeds the cost to configure value.

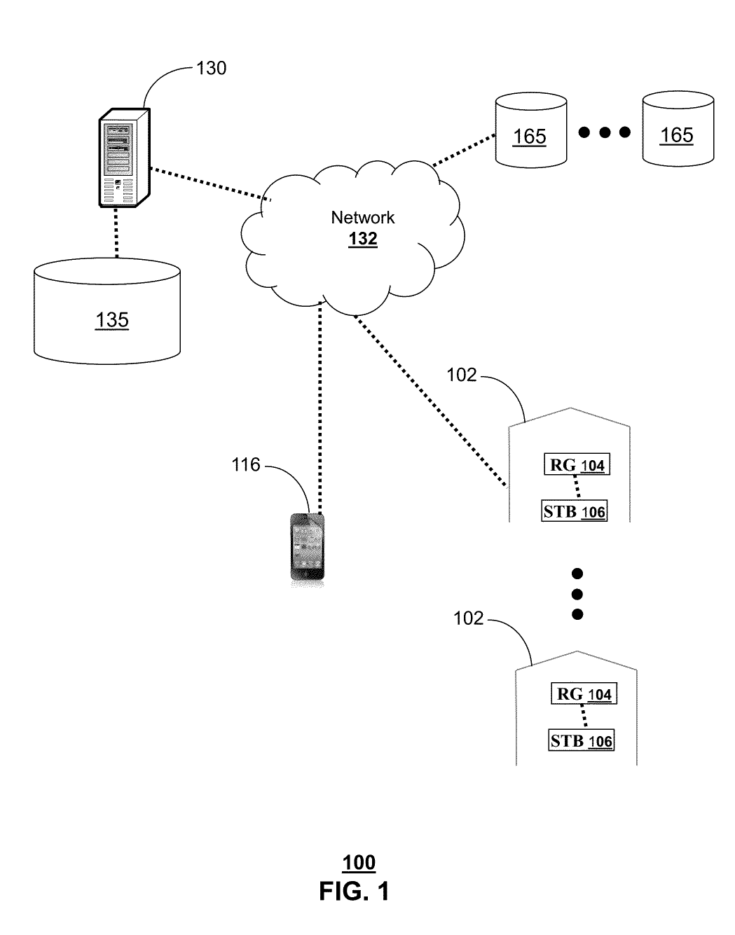

FIG. 1 depicts an illustrative embodiment of a system 100 for improving equipment maintenance for a service provider that provides communication services to any number of customer premises 102 (e.g., a residence, a building, or any other location to which communication services are provided by the service provider) over a network 132. The communication services can be of various types including voice, video, data and/or messaging. The particular provider equipment utilized for providing the services can vary and can include routers, switches, servers, hardwires, wireless devices, and so forth.

System 100 can include one or more servers 130 that can merge or otherwise process large datasets which can be obtained or retrieved from various systems 165, such as within a service provider's network. In one embodiment, the server 130 can store in a database 135 analyzed data (e.g., obtained from the systems 165) to facilitate management of maintenance for the network, including maintenance on user devices such as media devices (e.g., set top box (STB) 106), gateways (e.g., residential gateway (RG) 104), and/or communication devices 116. In one embodiment, the server 130 can be multiple servers that operate in a distributed environment where functions are divided amongst the different servers to increase processing efficiency.

The datasets can include various device diagnostic data, such as STB counters, communication device counters, broadband diagnostic logs, RG counters, VDSL counters, and/or STB WAP counters. The various counters can be based on various monitoring of performance, including dropped packets, dropped call session, user activity, or other quality or performance metrics that can be quantified and/or counted at the particular device or in associated with the particular device. In one embodiment, the datasets can include dispatch logs from technician site visits, customer care call logs, and/or historical trends of scorecard data that describes service or maintenance performance. In another embodiment, the server 130 can obtain configuration data associated with the customer premises 102 including types of connections (e.g., twisted pair, fiber-to-the-node, fiber-to-the-curb, fiber-to-the-home, co-axial, wireless, and so forth) and/or devices utilized in those connections (e.g., digital subscriber line access multiplexers (DSLAMs), routers, switches, and so forth).

In another embodiment, the server 130 can collect data associated with equipment at the network 132 and at the premises 102. The server 130 can analyze data associated with facets of the equipment that are variable and facets that are fixed. Variable, or changeable, aspects can include hardware versions, software versions, software configurations, capabilities and functionalities, cabling, wireless access, connectors, passive and/or active components. Fixed, or non-changeable, aspects of the network 132 and premises can include fixed length access links, levels of service, and/or types of capabilities that are desired by customers. In one or more embodiments, the changeable aspects in the configuration of the network 132 and/or premises can be changed to improve the customer experience to either some level of satisfaction or within some benchmark. Currently, such improvement, or optimization, is not systematic and does not take into account the complexities that exist with multiple variables involved. Further, a systematic approach to prioritizing and valuating the optimization against the cost to do so does not exist.

In one or more embodiment, the system 100 can include a collection of original data sources 165, such as databases associated with customer care, dispatch and maintenance, equipment counters, equipment inter-connect, ordering, key performance indicators, and/or a quality index that can based on customer perceived quality surveys. The server 130 can collect datasets from the data sources 165, which can be stored at a single database 135, which can be a “big data” platform. For example, the collected database 135 can be a distributed file system, such as a Hadoop distributed file system (HDFS), where datasets can be stored as clusters in a scalable database.

As the datasets are merged, predictive analytics (e.g., linear regression analysis) can be applied to characterize (e.g., quantify) the quality of a customer's experience for the communications service under a variety of configurations. For instance, a customer's experience can be characterized based on a specific configuration in effect at a customer site, such as in conjunction with the central office resources allocated (e.g., DSLAM LT cards). In one embodiment, a dataset of key performance parameters can serve as a proxy for perceived customer satisfaction or dissatisfaction with the performance of the service provider in provide services via the network 132. In one embodiment, linear regression analysis or other statistical analysis techniques can be applied to datasets for key performance parameters and customer satisfaction survey data. The server 130 can use the statistical analysis to identify which performance parameters are important and/or unimportant to customer satisfaction. For example, the server 130 can determine that disruption of services for communication devices are very important to customer satisfaction but that loss of television services at STBs due to weather conditions are not as important. The server 130 can thus refine the dataset of key performance indicators to identify which indicators are best predictors of customer satisfaction and/or dissatisfaction and, therefore, which key performance indicators should be most relied upon when determining how best to configure or reconfigure the network 132 for improving customer satisfaction (or to avoid customer dissatisfaction).

In one or more embodiments, the server 130 can perform linear regression analysis on datasets associated with historic configurations of equipment and devices of the network 132 and datasets associated with historic key performance indicators from the same circumstances (time, place, and customer). The server 130 can correlate various historic equipment and network configurations with historic key performance indicators that are known to correlate with customer satisfaction and/or customer dissatisfaction. The server 130 can generate a model from the linear regression analysis, where the model can be used to predict future key performance indicator values based upon alternative equipment configurations. In one or more embodiments, a linear regression model of configurations and key performance indicators can be used to determine a proposed configuration that can result in an improvement in a key performance indicator that is associated with customer satisfaction (or the avoidance of customer dissatisfaction).

For instance, a first threshold of performance for a key performance indicator can be determined for STB's of a first type, where the STB's of the first type use a first data buffer configuration, while a second threshold of performance for the key performance indicator can be determined for STB's of a second type that use a second data buffer configuration. The particular number of configurations can vary. In one embodiment, similar configurations can be merged such as STB's of a first type that are connected to the network via a fiber-to-the curb connection and STB's of the same first type that are connected to the network via a fiber-to-the-home connection. Whether or not similar configurations are merged can depend on an analysis of their similarities and whether the differences in the configuration significantly contribute to a distinction in quality of services as statistically demonstrated in the value of the key performance indicator. For example, it may be determined that the first data buffer configuration that uses fiber-to-the-curb compared with a second data buffer configuration that uses fiber-to-the-home does not significantly change the quality of service as demonstrated by key performance indicator. As the baseline for the customer experience is established via the predictive analytics applied to the data sets by the server 130, outlier detection can be performed to identify specific customer premises 102 where the provided services are not meeting the expectation or where the provided services can be substantially improved according to one or more key performance indicators.

For example, the server 130 can apply the linear regression model to a present dataset of configurations and, in conjunction with key performance indicators, can determine a quality threshold for a particular configuration. Based on this threshold, the server 130 can identify particular customer premises 102 with the particular configuration, where the rendered communications services are either not satisfying the quality threshold or where the quality performance for rendered communication services can be substantially improved.

In one or more embodiments, the server 130 can perform linear regression analysis of datasets associated with the key performance indicators and datasets associated with costs associated with care calls and/or costs associated with dispatching maintenance technicians to service customer issues. The service provider can incur costs when a customer calls for assistance with a problem and, especially, when the problem necessitates dispatching a technician. The server 130 can perform a statistical analysis where these costs are correlated to key performance indicators to determine those key performance indicators that are predictive of reduced care and dispatch costs. In one or more embodiments, the linear regression can result in a model the can predict improvements in customer care and dispatch costs that can result from specific improvements to key performance indicators.

In one or more embodiments, the server 130 can perform linear regression analysis of datasets associated with the key performance indicators and datasets associated with loss of customers or customer “churn.” Where key performance indicators can correlate to customer satisfaction and/or dissatisfaction based on customer survey data, statistical analysis of the key performance indicators and data for customer losses. The server 130 can perform a statistical analysis where these customer chum can be correlated to key performance indicators to determine those key performance indicators that are predictive for reducing customer losses. In one or more embodiments, the linear regression can result in a model the can predict improvements in customer churn that can result from specific improvements to key performance indicators.

In one or more embodiments, the server 130 can obtain device diagnostic data from the merged database 135 for a group of devices that provide communication services to a plurality of customer premises 102 over the network 132. The server 130 can obtain configuration data associated with the plurality of customer premises 102 and can obtain key performance indicators associated with the communication services of the plurality of customer premises. The key performance indicators can be of various types including based on video, broadband and/or voice services quality, such as obtained via customer surveys, counters, and so forth.

In one or more embodiments, the server 130 can determine, from a model based on key performance indicators and equipment configurations, a proposed change in configuration for a device that is used to provide communication services to a customer device 106 via the network 132. For example, the proposed change in configuration can be a change in setup of data buffer for a router in the signal path of the customer premises 102. The server 130 can apply a linear regression model to predict that the specific change in equipment configuration can improve a key performance parameter that will, in turn, improve customer satisfaction (or reduce customer dissatisfaction).

In one embodiment, the server 130 can apply linear regression to the cost of care/dispatch data, the customer churn data, the configuration data and the key performance indicators to identify a quality threshold (e.g., a quality baseline) based on a particular configuration. The server 130 can detect a subset of customer premises from among the plurality of customer premises 102 that are not satisfying the quality threshold. The server 130 can analyze a subset of the device diagnostic data that corresponds to the subset of customer premises to determine equipment (e.g., STB 106 or RG 104) associated with the subset of customer premises for maintenance. The server 130 can determine a history of dispatch maintenance for the plurality of customer premises (or a portion thereof) and can determine proposed changes to configurations of the equipment of the subset of customer premises according to the history of dispatch maintenance. In one or more embodiments, the proposed configuration can be on user equipment that is functioning but is not functioning to provide services that meet the desired quality threshold. The corrective action can be equipment maintenance, equipment replacement, equipment re-configuration, software updates, and so forth.

In one or more embodiments, the server 130 can determine from a model based on key performance indicators and cost of care/dispatch that a predicted change in the cost of care/dispatch can result from a predicted improvement in the key performance indicator for a proposed change in configuration at the customer premises. For example, a configuration change could be proposed that will improve some key performance indicator but not a key performance indicator that is closely correlated with cost of care/dispatch. For example, the configuration chance could improve a key performance indicator associated with data download speeds for a communication device 116. While the improvement can enhance customer satisfaction, it is possible that this satisfaction improvement would not result in reduced costs for customer care or dispatch. For example, at the current level of performance, the customer may not be troubled enough by the download performance to actually call for assistance. In another example, the customer might be troubled enough to call in a problem, but the problem can be fixed remotely, perhaps by setting a configuration code at a remote server, without incurring a substantial cost to the service provider. In this case, the server 130 can determine, from the linear regression model, that proposed configuration change and resulting improvement in key performance indicators is of limited value from a cost of care/dispatch standpoint. This result can cause the proposed configuration change to receive a low value for cost of care/dispatch. Alternatively, where the proposed configuration change correlates to a significant predicted savings for cost of care/dispatch for the customer premises, then the proposed configuration change can receive a high value for purposes of prioritization.

In one or more embodiments, the server 130 can determine from a model based on key performance indicators and customer churn that a predicted change in customer churn can result from a predicted improvement in the key performance indicator for a proposed change in configuration at the customer premises. For example, a configuration change could be proposed that will improve some key performance indicator but not the key performance indicator may or may not be closely correlated with customer churn. Returning to the prior example, the configuration chance could improve a key performance indicator associated with data download speeds for a communication device 116. An improvement in satisfaction could result, and while the improvement might not reduced costs for customer care or dispatch, it might improve customer loyalty and reduce churn. In this case, the server 130 can determine, from the linear regression model, that proposed configuration change and resulting improvement in key performance indicators is of significant value from a standpoint of reducing customer chum. The proposed configuration change can receive a high value for purposes of prioritization.

It is recognized that implementation of a change in configuration can require changes in software, hardware, network routing, and/or location of equipment. These changes can require the dispatch of a technician and/or can be accomplished via remote actions. In either case, actions that are taken to alter the configuration can require identifiable expenditures. In one or more embodiments, the server 130 can predict the cost of changing the configuration. In turn, the server 130 can compare the anticipated cost for changing the configuration with an anticipated value of improvements in cost of care/dispatch and/or customer churn that are predicted for the configuration change. Where the anticipated costs for implementing the configuration are less than the beneficial reductions in cost if care/maintenance and/or customer chum, then the server 130 can recommend the proposed change in configuration to a dispatch server.

In one embodiment, the server 130 can obtain call records associated with maintenance for the plurality of customer premises 102 and can further apply the linear regression to the call records. In one embodiment, the server 130 can evaluate a success of the corrective actions for the equipment of the subset of customer premises and can revise dispatch records according to the evaluating, where the linear regression is applied to the dispatch records. In one embodiment, the device diagnostic data can include one or more of set top box counter data, residential gateway counter data, very-high-bit-rate digital subscriber line counter data, or wireless access point counter data.

In one embodiment, the configuration data can describe a hardwire connection (e.g., coaxial, fiber-to-the-node, fiber-to-the-curb, and so forth) used by the plurality of customer premises 102. In one embodiment, the server 130 can generate a dispatch notice identifying the corrective action and customer premises of the subset of customer premises where the maintenance is to occur. In one embodiment, the server 130 can obtain dispatch records associated with site visits for the plurality of customer premises, where the linear regression is applied to the dispatch records. In one embodiment, the server 130 can obtain historical records associated with service performance of the plurality of customer premises, where the linear regression is applied to the historical records.

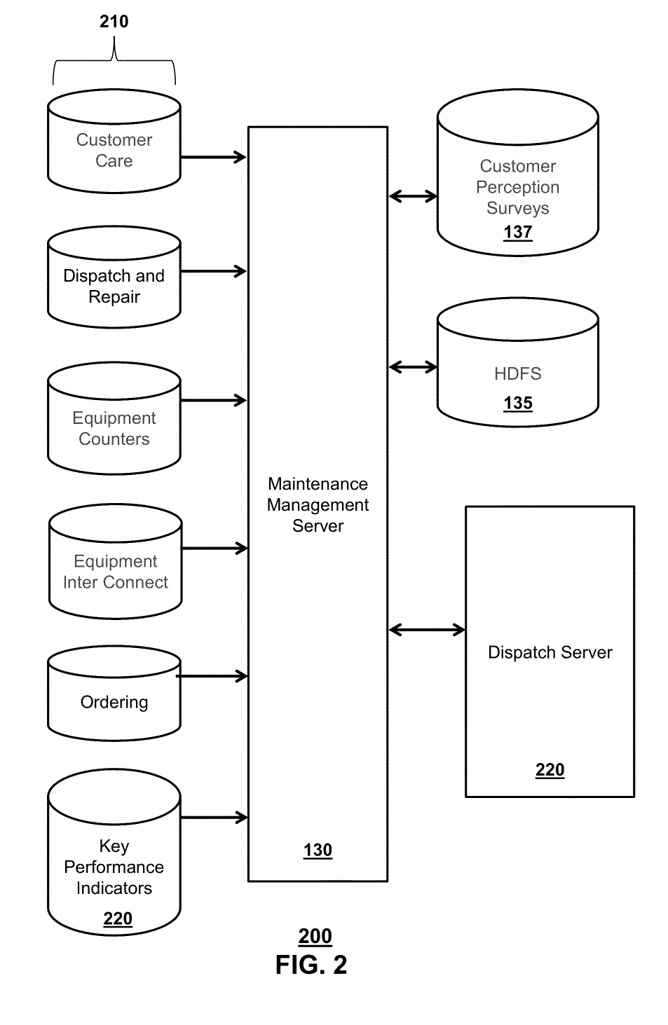

FIG. 2 depicts an illustrative embodiment of data collection by the server 130 resulting in prescriptive dispatch actions. Server 130 can obtain (e.g., from different systems and/or devices) various data 210 which can include one or more of dispatch records, ordering data, RG counters, VDSL counters, STB counters, wiring configurations, or customer care calls. Server 130 can also obtain quality key performance indicators 220 which can be static or can be dynamic changing over time, such as based on changing demographics of the users that may have different perceptions of quality than other users corresponding to other demographics. The server 130 then can engage in predictive analytics (e.g., via linear regression analysis) based on all or a portion of the data 210 as merged and stored at the HDFS database 135, based the key performance indicators 220, and the customer perception surveys 137.

By using predictive analytics, configuration changes can be identified. The proposed configuration changes can include generating messages that can be sent to a dispatch server 220. The success of the implemented configurations changes can be evaluated, including based on the key performance indicators, subsequent customer care calls for the particular customer premises, or other data indicating whether the services, subsequent to the corrective action, are now satisfying a quality threshold and/or demonstrated expected improvements in key performance indicators. In one or more embodiments, the success or failure of the configuration changes can be integrated with the dispatch records and the history of dispatch maintenance of data 210 so that subsequent predictive analytics can take this data into account when determining future configuration changes for a particular configuration at a customer premises.

In one or more embodiments, the data 210 can be broken up or otherwise categorized based on other factors, such as types of services being provided, geographic regions of the customer premises, history or frequency of complaints by a user, weather conditions at time of data collection, amount of network activity at time of data collection, other anomalies at time of data collection, and so forth.

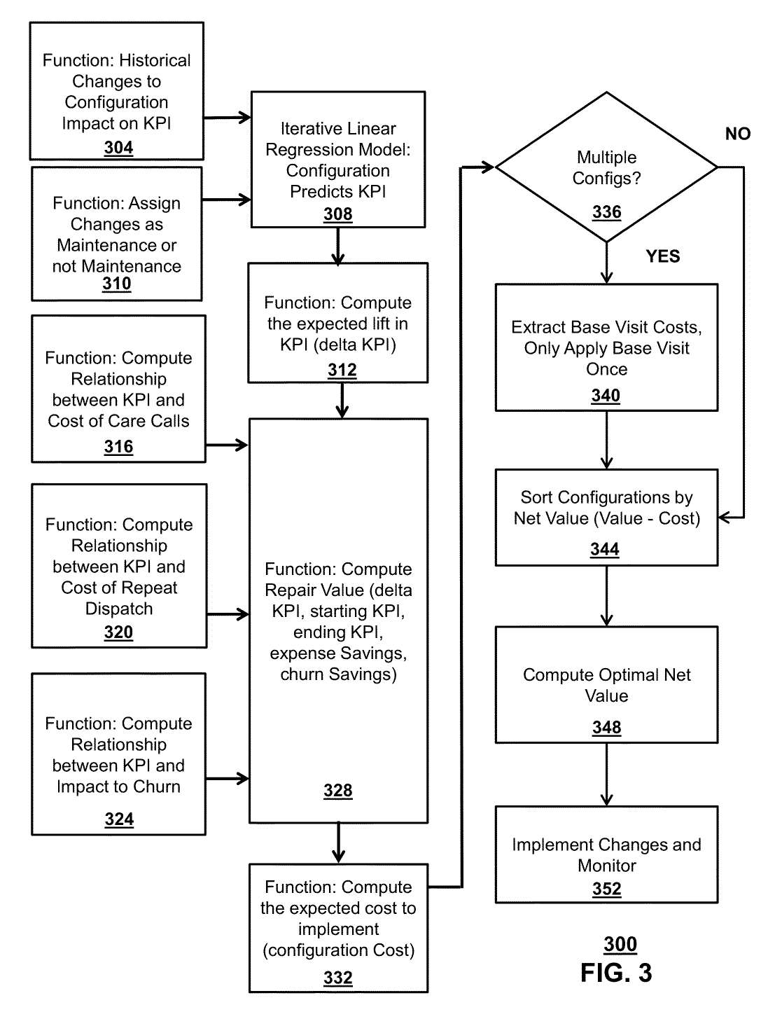

FIG. 3 depicts an illustrative embodiment of a method used by system 100 to employ predictive analytics to data to determine configuration improvements. At 304, the server 130 can perform a function for correlating historical changes to configuration with the historic key performance indicators that represent customer perceived quality. In one embodiment, the server 130 can perform linear regression of the historic configuration data and the key performance indicator data to generate linear regression model. In one embodiment, the model can predict the impact of configuration changes on customer perceived quality metrics. The model can use historical data to qualify the individual impacts to quality for each component and/or for all components in the signal path. The impacts to quality metrics for all components can be analyzed, and a single configuration set can be created and/or cataloged for the customer.

At 308, the server 130 can provide an overall feedback loop to update the linear regression model, iteratively, with new key performance indicators that are generated based on new configurations. In addition to using historical data to identify configuration combinations that can impact quality of service (as adjudged by the key performance indicators), the server 130 can create a feedback loop. The feedback loop can compare past configurations against same account changes and against resulting quality metric impacts to further improve the predictability of the model.

At step 310, the server 130 can assign a change to a configuration as preformed as maintenance or as not as maintenance. The iterative linear regression model that correlates key performance indicators to configurations can be improved as the existence of a maintenance activity is taken into account. A maintenance activity can described as an activity that required a technician to perform maintenance activities at the customer premises. A non-maintenance activity can be an activity, where a customer perceived quality has changed, but no recorded dispatch is present. For example, a self-correcting event or an event such as an over-the-air software upgrade can improve a key performance indicator without requiring maintenance.

At 312, the server 130 can determine an expected change in a key performance indicator (delta KPI) that is associated with a proposed configuration change. For example, a configuration change could involve swapping from hardware type A to hardware type B or upgrading software on hardware X from revision 1 to revision 2. The server 130 can perform a calculation using the linear regression model.

At step 316, the server 130 can calculate the ongoing relationship between a key performance indicator and cost of calls into the Care Organization. The server 130 can determine a model that relates the key performance indicator and cost of calls. The server 130 can determine either a cost savings or an expense increase that occurs as a customer reaches a level of service associated with a change in a key performance indicator. The server 130 can assign a value for changes in cost of calls that are predicted.

At step 320, the server 130 can calculate the ongoing relationship between a key performance indicator and cost of dispatching a technician to perform service. The server 130 can determine a model that relates the key performance indicator and cost of dispatches. The server 130 can determine either a cost savings or an expense increase that occurs as a customer reaches a level of service associated with a change in a key performance indicator. The server 130 can assign a value for changes in cost of dispatch that are predicted.

At step 324, the server 130 can calculate the ongoing relationship between a key performance indicator and customer loss or churn. The server 130 can determine a model that relates the key performance indicator and customer chum. The server 130 can determine either increase or a decrease in customer churn that occurs as a customer reaches a level of service associated with a change in a key performance indicator. The server 130 can assign a value for changes in cost of loss that are predicted.

At step 328, the server 130 can compute a value for implementing the change in the configuration. The server 130 can input a starting key performance indicator value, and an ending key performance indicator value as derived from the delta key performance indicator. The server 130 can output a predicted expense savings (cost of calls/dispatch) and churn savings. At step 332, the server 130 can determine an expected cost to implement the proposed configuration.

At step 336, the server 130 can determine if multiple configurations are identified for a single customer. If yes, then configurations costs can be reduced to only account for a single site visit. If multiple configurations exist at a single customer site at step 336, then the server 130 can removed the base cost for the visit from all but one of the configuration at step 340. At step 344, the server 130 can prioritize the configuration across the customer base by a net value, which can be defined as a value of the configuration change (in terms of improvement in cost and/or chum) less the cost of performing the configuration change.

At step 348, the server 130 can determine an optimal set of configurations to dispatch among all customers that are identified with proposed changes in configuration. The server 130 can also include known maintenance in the determination of an optimal set of configurations. The server 130 can depict the optimal set of configurations on a graph where the net value is on a first axis, and a number of configurations (or a cost of configurations) is on a second axis. As the number of configurations increases, so can the net value. However, where the cost of implementing an additional configuration outweighs the value of performing the configuration, then the curve will level off and start to decline. An optimal configuration set can be defined as including configurations up to the point at which the net value stops rising.

At step 352, the server 130 can implement the configuration change and then monitor for results from the implementation.

In one embodiment, the server 130 can determine a history of dispatch maintenance for the plurality of customer premises based on the dispatch records, and can determine corrective actions for the equipment of the subset of customer premises according to the history of dispatch maintenance. In one embodiment, the server 130 can evaluate a success of the configuration changes for the equipment of the subset of customer premises, and can revise the dispatch records according to the evaluating.

In one embodiment, the device diagnostic data includes set top box counter data, residential gateway counter data, very-high-bit-rate digital subscriber line counter data, wireless access point counter data, or a combination thereof. In one embodiment, the group of devices includes set top boxes and residential gateways. In one embodiment, the configuration data describes a hardwire connection used by the plurality of customer premises. In one embodiment, the server 130 can determine configuration changes for the equipment of the subset of customer premises according to a history of dispatch maintenance, can determine tools for the corrective actions for the equipment of the subset of customer premises, and can generate a dispatch notice identifying the corrective action, the tools for the corrective actions, and a customer premises of the subset of customer premises.

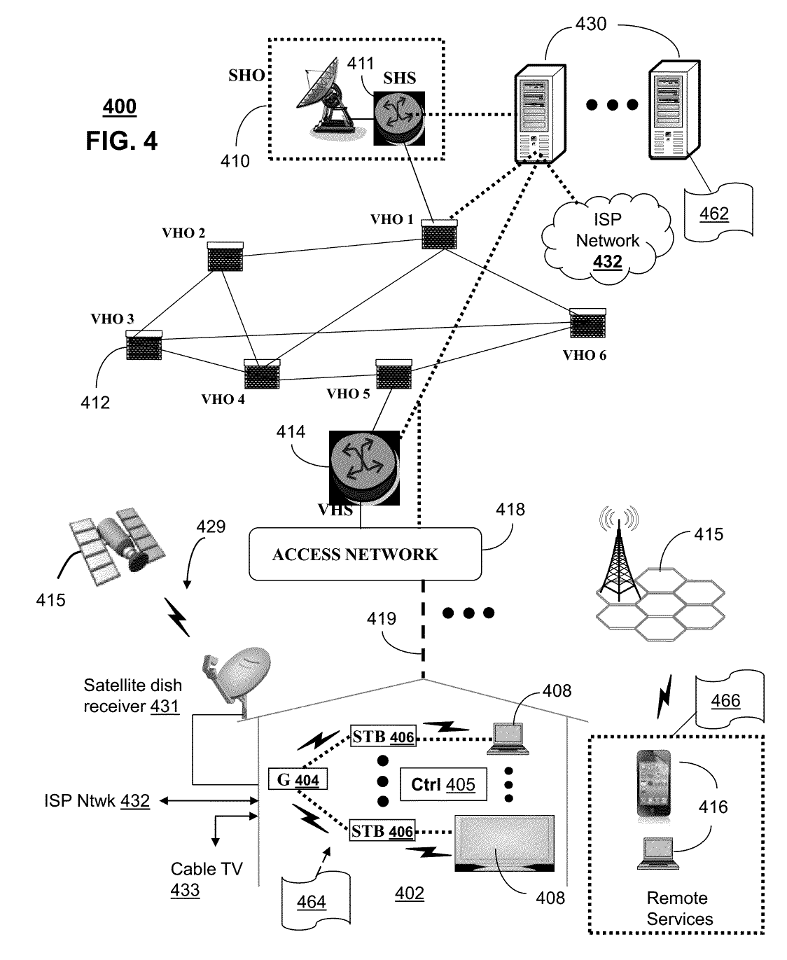

FIG. 4 depicts an illustrative embodiment of a communication system 400 for delivering media content and performing predictive analytics on large datasets to enable recommending configuration changes for improving the performance of the communication system 400. The communication system 400 can represent an Internet Protocol Television (IPTV) media system. Communication system 400 can be overlaid or operably coupled with system 100 as another representative embodiment of communication system 400. For instance, one or more devices illustrated in the communication system 400 of FIG. 4 can apply linear regression to historic configuration data and historic key performance indicators to generate a first model and can correlate the historic key performance indicators and historic cost of maintenance data to determine a second model. The devices of the communication system 400 can determine, according to the first model, a configuration adjustment of a first element of the network for generating an improvement in first key performance indicators that are associated with first customer premises of the plurality of customer premises, and determine, according to the second model, a maintenance cost improvement according to the improvement in first key performance indicators. The devices of the communication system 400 can determine a configuration cost associated with the configuration adjustment of the first element, determine whether the maintenance improvement value exceeds the cost to configure value, and transmit a recommendation for performing the configuration adjustment of the first element to a dispatch server responsive to determining that the maintenance improvement value exceeds the cost to configure value.

System 400 enables obtaining call records associated with maintenance for the plurality of customer premises; and obtaining historical records associated with service performance of the plurality of customer premises, where predictive analytics via the linear regression can be applied to the call records and the historical records. System 400 enables determining a history of dispatch maintenance for the plurality of customer premises based on the dispatch records; and determining the corrective actions for the equipment of the subset of customer premises according to the history of dispatch maintenance. System 400 enables the device diagnostic data to include set top box counter data, residential gateway counter data, very-high-bit-rate digital subscriber line counter data, and wireless access point counter data. System 400 enables the configuration data to describe a hardwire connection used by the plurality of customer premises.

The IPTV media system can include a super head-end office (SHO) 410 with at least one super headend office server (SHS) 411 which receives media content from satellite and/or terrestrial communication systems. In the present context, media content can represent, for example, audio content, moving image content such as 2D or 3D videos, video games, virtual reality content, still image content, and combinations thereof. The SHS server 411 can forward packets associated with the media content to one or more video head-end servers (VHS) 414 via a network of video head-end offices (VHO) 412 according to a multicast communication protocol.

The VHS 414 can distribute multimedia broadcast content via an access network 418 to commercial and/or residential buildings 402 housing a gateway 404 (such as a residential or commercial gateway). The access network 418 can represent a group of DSLAMs located in a central office or a service area interface that provide broadband services over fiber optical links or copper twisted pairs 419 to buildings 402. The gateway 404 can use communication technology to distribute broadcast signals to media processors 406 such as STBs which in turn present broadcast channels to media devices 408 such as computers or television sets managed in some instances by a media controller 407 (such as an infrared or RF remote controller).

The gateway 404, the media processors 406, and media devices 408 can utilize tethered communication technologies (such as coaxial, powerline or phone line wiring) or can operate over a wireless access protocol such as Wireless Fidelity (WiFi), Bluetooth®, Zigbee®, or other present or next generation local or personal area wireless network technologies. By way of these interfaces, unicast communications can also be invoked between the media processors 406 and subsystems of the IPTV media system for services such as video-on-demand (VoD), browsing an electronic programming guide (EPG), or other infrastructure services.

A satellite broadcast television system 429 can be used in the media system of FIG. 4. The satellite broadcast television system can be overlaid, operably coupled with, or replace the IPTV system as another representative embodiment of communication system 400. In this embodiment, signals transmitted by a satellite 415 that include media content can be received by a satellite dish receiver 431 coupled to the building 402. Modulated signals received by the satellite dish receiver 431 can be transferred to the media processors 406 for demodulating, decoding, encoding, and/or distributing broadcast channels to the media devices 408. The media processors 406 can be equipped with a broadband port to an Internet Service Provider (ISP) network 432 to enable interactive services such as VoD and EPG as described above.

In yet another embodiment, an analog or digital cable broadcast distribution system such as cable TV system 433 can be overlaid, operably coupled with, or replace the IPTV system and/or the satellite TV system as another representative embodiment of communication system 400. In this embodiment, the cable TV system 433 can also provide Internet, telephony, and interactive media services.

The subject disclosure can apply to other present or next generation over-the-air and/or landline media content services system.

Some of the network elements of the IPTV media system can be coupled to one or more computing devices 430, a portion of which can operate as a web server for providing web portal services over the ISP network 432 to wireline media devices 408 or wireless communication devices 416.

Communication system 400 can also provide for all or a portion of the computing devices 430 to function as a prescriptive maintenance dispatcher (herein referred to as server 430). The server 430 can use computing and communication technology to perform function 462, which can include among other things, one or more of the functions described with respect to server 130 of FIG. 1, including applying linear regression to historic configuration data and historic key performance indicators to generate a first model and correlating the historic key performance indicators and historic cost of maintenance data to determine a second model. The function 462 can include determining, according to the first model, a configuration adjustment of a first element of the network for generating an improvement in first key performance indicators that are associated with first customer premises of the plurality of customer premises, and determining, according to the second model, a maintenance cost improvement according to the improvement in first key performance indicators. The function 462 can determining a configuration cost associated with the configuration adjustment of the first element, determining whether the maintenance improvement value exceeds the cost to configure value, and transmitting a recommendation for performing the configuration adjustment of the first element to a dispatch server responsive to determining that the maintenance improvement value exceeds the cost to configure value.

The media processors 406 (and/or residential gateways 404) and wireless communication devices 416 can be provisioned with software functions 464 and 466, respectively, to utilize the services of server 430. For instance, functions 464 and 466 can include providing various data utilized in the predictive analytics of the server 130, including counter data or other information indicative of quality performance at the particular device.

Multiple forms of media services can be offered to media devices over landline technologies such as those described above. Additionally, media services can be offered to media devices by way of a wireless access base station 417 operating according to common wireless access protocols such as Global System for Mobile or GSM, Code Division Multiple Access or CDMA, Time Division Multiple Access or TDMA, Universal Mobile Telecommunications or UMTS, World interoperability for Microwave or WiMAX, Software Defined Radio or SDR, Long Term Evolution or LTE, and so on. Other present and next generation wide area wireless access network technologies can be used in one or more embodiments of the subject disclosure.

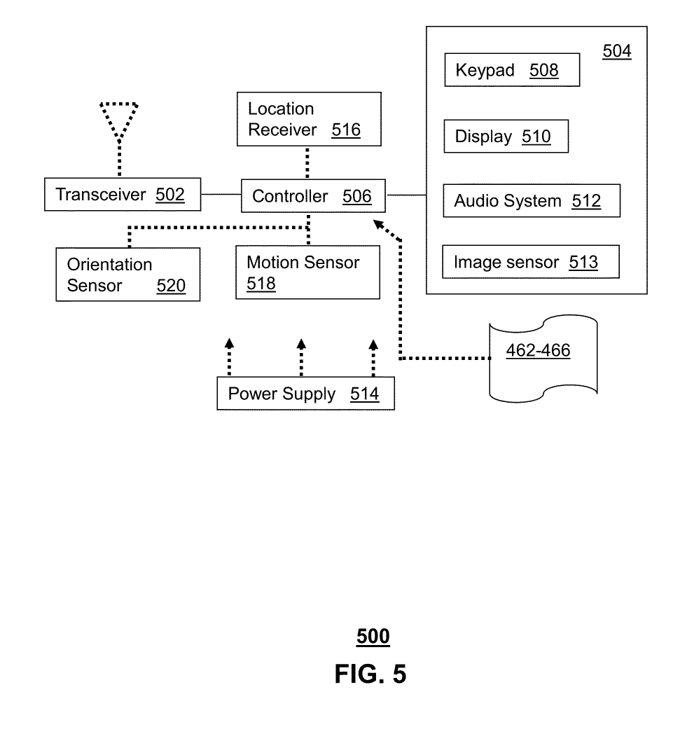

FIG. 5 depicts an illustrative embodiment of a communication device 500. Communication device 500 can serve in whole or in part as an illustrative embodiment of the devices depicted in FIGS. 1-2 and FIG. 4 and can be configured to perform portions of method 300 of FIG. 3. For example, communication device 500 can be a configuration server, a media processor 106, a gateway device 104, a database server 135, and/or a mobile communication device 116. The communication device 500 can be a configuration server that can apply linear regression to historic configuration data and historic key performance indicators to generate a first model and can correlate the historic key performance indicators and historic cost of maintenance data to determine a second model. The communication device 500 can determine, according to the first model, a configuration adjustment of a first element of the network for generating an improvement in first key performance indicators that are associated with first customer premises of the plurality of customer premises, and determine, according to the second model, a maintenance cost improvement according to the improvement in first key performance indicators. The communication device 500 can determine a configuration cost associated with the configuration adjustment of the first element, determine whether the maintenance improvement value exceeds the cost to configure value, and transmit a recommendation for performing the configuration adjustment of the first element to a dispatch server responsive to determining that the maintenance improvement value exceeds the cost to configure value.

Communication device 500 can comprise a wireline and/or wireless transceiver 502 (herein transceiver 502), a user interface (UI) 504, a power supply 514, a location receiver 516, a motion sensor 518, an orientation sensor 520, and a controller 506 for managing operations thereof. The transceiver 502 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 502 can also be adapted to support circuit-switched wireline access technologies (such as PSTN), packet-switched wireline access technologies (such as TCP/IP, VoIP, etc.), and combinations thereof.

The UI 504 can include a depressible or touch-sensitive keypad 508 with a navigation mechanism such as a roller ball, a joystick, a mouse, or a navigation disk for manipulating operations of the communication device 500. The keypad 508 can be an integral part of a housing assembly of the communication device 500 or an independent device operably coupled thereto by a tethered wireline interface (such as a USB cable) or a wireless interface supporting for example Bluetooth®. The keypad 508 can represent a numeric keypad commonly used by phones, and/or a QWERTY keypad with alphanumeric keys. The UI 504 can further include a display 510 such as monochrome or color LCD (Liquid Crystal Display), OLED (Organic Light Emitting Diode) or other suitable display technology for conveying images to an end user of the communication device 500. In an embodiment where the display 510 is touch-sensitive, a portion or all of the keypad 508 can be presented by way of the display 510 with navigation features.

The display 510 can use touch screen technology to also serve as a user interface for detecting user input. As a touch screen display, the communication device 500 can be adapted to present a user interface with graphical user interface (GUI) elements that can be selected by a user with a touch of a finger. The touch screen display 510 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 510 can be an integral part of the housing assembly of the communication device 500 or an independent device communicatively coupled thereto by a tethered wireline interface (such as a cable) or a wireless interface.

The UI 504 can also include an audio system 512 that utilizes audio technology for conveying low volume audio (such as audio heard in proximity of a human ear) and high volume audio (such as speakerphone for hands free operation). The audio system 512 can further include a microphone for receiving audible signals of an end user. The audio system 512 can also be used for voice recognition applications. The UI 504 can further include an image sensor 513 such as a charged coupled device (CCD) camera for capturing still or moving images.

The power supply 514 can utilize common power management technologies such as replaceable and rechargeable batteries, supply regulation technologies, and/or charging system technologies for supplying energy to the components of the communication device 500 to facilitate long-range or short-range portable applications. Alternatively, or in combination, the charging system can utilize external power sources such as DC power supplied over a physical interface such as a USB port or other suitable tethering technologies.

The location receiver 516 can utilize location technology such as a global positioning system (GPS) receiver capable of assisted GPS for identifying a location of the communication device 500 based on signals generated by a constellation of GPS satellites, which can be used for facilitating location services such as navigation. The motion sensor 518 can utilize motion sensing technology such as an accelerometer, a gyroscope, or other suitable motion sensing technology to detect motion of the communication device 500 in three-dimensional space. The orientation sensor 520 can utilize orientation sensing technology such as a magnetometer to detect the orientation of the communication device 500 (north, south, west, and east, as well as combined orientations in degrees, minutes, or other suitable orientation metrics).

The communication device 500 can use the transceiver 502 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 500.

Other components not shown in FIG. 5 can be used in one or more embodiments of the subject disclosure. For instance, the communication device 500 can include a reset button (not shown). The reset button can be used to reset the controller 506 of the communication device 500. In yet another embodiment, the communication device 500 can also include a factory default setting button positioned, for example, below a small hole in a housing assembly of the communication device 500 to force the communication device 500 to re-establish factory settings. In this embodiment, a user can use a protruding object such as a pen or paper clip tip to reach into the hole and depress the default setting button. The communication device 500 can also include a slot for adding or removing an identity module such as a Subscriber Identity Module (SIM) card. SIM cards can be used for identifying subscriber services, executing programs, storing subscriber data, and so forth.

The communication device 500 as described herein can operate with more or less of the circuit components shown in FIG. 5. These variant embodiments can be used in one or more embodiments of the subject disclosure.

The communication device 500 can be adapted to perform the functions of the server 130 or the server 430, the media processor 406, the media devices 408, or the portable communication devices 416 of FIG. 4. It will be appreciated that the communication device 500 can also represent other devices that can operate in the systems of FIGS. 1 and/or 4 such as a gaming console and a media player. In addition, the controller 506 can be adapted in various embodiments to perform the functions 462-462.

Upon reviewing the aforementioned embodiments, it would be evident to an artisan with ordinary skill in the art that said embodiments can be modified, reduced, or enhanced without departing from the scope of the claims described below. For example, the dispatch maintenance and corrective action can be directed to provider equipment that is determined to be causing the services at the particular customer premises to fall below the desired quality threshold. Other embodiments can be used in the subject disclosure.

It should be understood that devices described in the exemplary embodiments can be in communication with each other via various wireless and/or wired methodologies. The methodologies can be links that are described as coupled, connected and so forth, which can include unidirectional and/or bidirectional communication over wireless paths and/or wired paths that utilize one or more of various protocols or methodologies, where the coupling and/or connection can be direct (e.g., no intervening processing device) and/or indirect (e.g., an intermediary processing device such as a router).

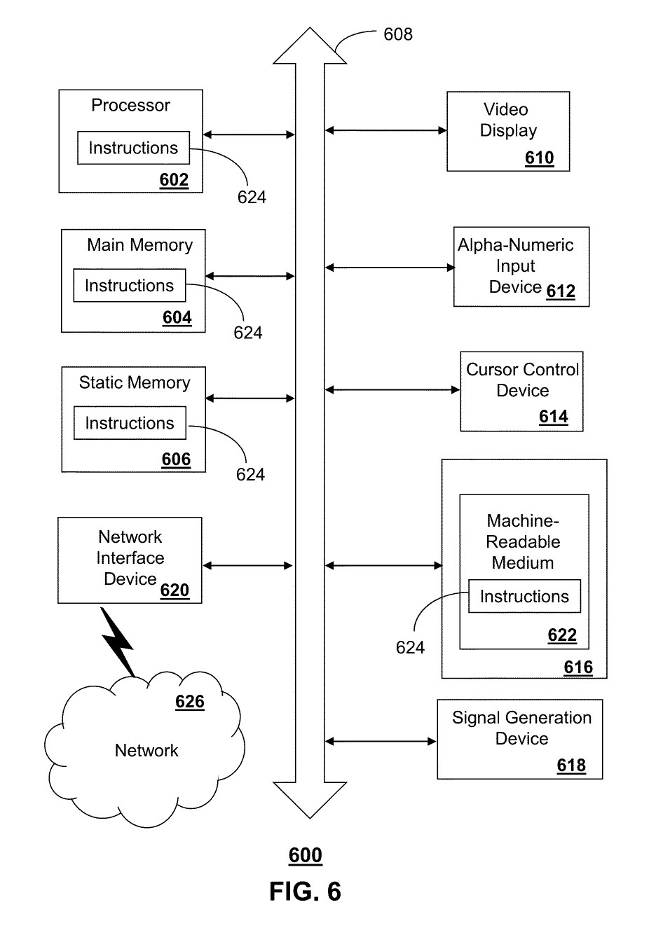

FIG. 6 depicts an exemplary diagrammatic representation of a machine in the form of a computer system 600 within which a set of instructions, when executed, may cause the machine to perform any one or more of the methods described above. One or more instances of the machine can operate, for example, as the server 130 or server 430 to perform predictive analytics to determine prescriptive configuration changes. The computer system 600 can operate as a configuration server 130, a database server 135, a media processor 106, a gateway device 104, and/or a mobile communication device 116. In some embodiments, the machine may be connected (e.g., using a network 626) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

The computer system 600 may include a processor (or controller) 602 (e.g., a central processing unit (CPU)), a graphics processing unit (GPU, or both), a main memory 604 and a static memory 606, which communicate with each other via a bus 608. The computer system 600 may further include a display unit 610 (e.g., a liquid crystal display (LCD), a flat panel, or a solid state display). The computer system 600 may include an input device 612 (e.g., a keyboard), a cursor control device 614 (e.g., a mouse), a disk drive unit 616, a signal generation device 618 (e.g., a speaker or remote control) and a network interface device 620. In distributed environments, the embodiments described in the subject disclosure can be adapted to utilize multiple display units 610 controlled by two or more computer systems 600. In this configuration, presentations described by the subject disclosure may in part be shown in a first of the display units 610, while the remaining portion is presented in a second of the display units 610.

The disk drive unit 616 may include a tangible computer-readable storage medium 622 on which is stored one or more sets of instructions (e.g., software 624) embodying any one or more of the methods or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute tangible computer-readable storage media.

Dedicated hardware implementations including, but not limited to, application specific integrated circuits, programmable logic arrays and other hardware devices can likewise be constructed to implement the methods described herein. Application specific integrated circuits and programmable logic array can use downloadable instructions for executing state machines and/or circuit configurations to implement embodiments of the subject disclosure. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the subject disclosure, the operations or methods described herein are intended for operation as software programs or instructions running on or executed by a computer processor or other computing device, and which may include other forms of instructions manifested as a state machine implemented with logic components in an application specific integrated circuit or field programmable gate array. Furthermore, software implementations (e.g., software programs, instructions, etc.) including, but not limited to, distributed processing or component/object distributed processing, parallel processing, or virtual machine processing can also be constructed to implement the methods described herein. It is further noted that a computing device such as a processor, a controller, a state machine or other suitable device for executing instructions to perform operations or methods may perform such operations directly or indirectly by way of one or more intermediate devices directed by the computing device.

While the tangible computer-readable storage medium 622 is shown in an example embodiment to be a single medium, the term “tangible computer-readable storage medium” should be taken to include a single medium or multiple media (e.g., a centralized or distributed database, and/or associated caches and servers) that store the one or more sets of instructions. The term “tangible computer-readable storage medium” shall also be taken to include any non-transitory medium that is capable of storing or encoding a set of instructions for execution by the machine and that cause the machine to perform any one or more of the methods of the subject disclosure. The term “non-transitory” as in a non-transitory computer-readable storage includes without limitation memories, drives, devices and anything tangible but not a signal per se.

The term “tangible computer-readable storage medium” shall accordingly be taken to include, but not be limited to: solid-state memories such as a memory card or other package that houses one or more read-only (non-volatile) memories, random access memories, or other re-writable (volatile) memories, a magneto-optical or optical medium such as a disk or tape, or other tangible media which can be used to store information. Accordingly, the disclosure is considered to include any one or more of a tangible computer-readable storage medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are from time-to-time superseded by faster or more efficient equivalents having essentially the same functions. Wireless standards for device detection (e.g., RFID), short-range communications (e.g., Bluetooth®, WiFi, Zigbee®), and long-range communications (e.g., WiMAX, GSM, CDMA, LTE) can be used by computer system 600.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. The exemplary embodiments can include combinations of features and/or steps from multiple embodiments. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure. In one or more embodiments, features that are positively recited can also be excluded from the embodiment with or without replacement by another component or step. The steps or functions described with respect to the exemplary processes or methods can be performed in any order. The steps or functions described with respect to the exemplary processes or methods can be performed alone or in combination with other steps or functions (from other embodiments or from other steps that have not been described).

Less than all of the steps or functions described with respect to the exemplary processes or methods can also be performed in one or more of the exemplary embodiments. Further, the use of numerical terms to describe a device, component, step or function, such as first, second, third, and so forth, is not intended to describe an order or function unless expressly stated so. The use of the terms first, second, third and so forth, is generally to distinguish between devices, components, steps or functions unless expressly stated otherwise. Additionally, one or more devices or components described with respect to the exemplary embodiments can facilitate one or more functions, where the facilitating (e.g., facilitating access or facilitating establishing a connection) can include less than every step needed to perform the function or can include all of the steps needed to perform the function.

In one or more embodiments, a processor (which can include a controller or circuit) has been described that performs various functions. It should be understood that the processor can be multiple processors, which can include distributed processors or parallel processors in a single machine or multiple machines. The processor can be used in supporting a virtual processing environment. The virtual processing environment may support one or more virtual machines representing computers, servers, or other computing devices. In such virtual machines, components such as microprocessors and storage devices may be virtualized or logically represented. The processor can include a state machine, application specific integrated circuit, and/or programmable gate array including a Field PGA. In one or more embodiments, when a processor executes instructions to perform “operations”, this can include the processor performing the operations directly and/or facilitating, directing, or cooperating with another device or component to perform the operations.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A server, comprising:
a processor; and
a memory that stores executable instructions that, when executed by the processor, facilitate performance of operations, comprising:
applying linear regression to historic configuration data and historic key performance indicators to generate a first model, wherein the historic configuration data is associated with elements that provide communication services to a plurality of customer premises of a plurality of users over a network and wherein the historic key performance indicators are associated with the communication services of the plurality of customer premises;
correlating the historic key performance indicators and historic cost of maintenance data to determine a second model, wherein the historic cost of maintenance data is associated with the communication services of the plurality of customer premises;
determining, according to the first model, a configuration adjustment of a first element of the network for generating an improvement in first key performance indicators that are associated with first customer premises of the plurality of customer premises;
determining, according to the second model, a maintenance cost improvement according to the improvement in first key performance indicators, wherein the maintenance cost improvement is assigned a maintenance improvement value;
determining a configuration cost associated with the configuration adjustment of the first element, wherein the configuration cost is assigned a cost to configure value;
determining whether the maintenance improvement value exceeds the cost to configure value; and
transmitting a recommendation for performing the configuration adjustment of the first element to a dispatch server responsive to determining that the maintenance improvement value exceeds the cost to configure value.

2. The server of claim 1, wherein the operations further comprise:
correlating historic customer lifetime data and the historic key performance indicators to determine a third model, wherein the historic customer lifetime data is associated with the communication services of the plurality of customer premises; and
determining, according to the third model, a customer lifetime improvement according to the improvement in first key performance indicators, wherein the customer lifetime improvement is assigned a lifetime improvement value, and wherein the maintenance improvement value further comprises the lifetime improvement value.

3. The server of claim 2, wherein the operations further comprise determining whether the configuration adjustment of the first element requires a dispatch of a technician, wherein the determining of the configuration cost comprises a dispatch cost if the configuration adjustment requires the dispatch of the technician.

4. The server of claim 3, wherein the operations further comprise determining from the dispatch server whether a dispatch event has been previously scheduled for the first customer premises for a purpose other than the configuration adjustment, wherein the determining of the configuration cost does not comprise the dispatch cost if the dispatch event has been previously scheduled.

5. The server of claim 1, wherein the first element of the network comprises a device.

6. The server of claim 1, wherein the first element of the network comprises a signal path for the communication services.

7. The server or claim 1, wherein the operations further comprise:
determining, according to the first model, a second configuration adjustment of a second element of the network to generate an second improvement in first key performance indicators that are associated with the communication services to first customer premises of the plurality of customer premises;
determining, according to the second model, a second maintenance cost improvement according to the second improvement in first key performance indicators, wherein the second maintenance cost improvement is added to the maintenance improvement value; and
determining a second configuration cost associated with the second configuration adjustment of the second element, wherein the second configuration cost is added to the cost to configure value, and wherein the second configuration adjustment is added to the recommendation.

8. The server of claim 1, wherein the operations further comprise:
monitoring for a confirmation of the configuration adjustment of the first element;
detecting the confirmation;
obtaining key performance indicator data associated with the first premises subsequent to the confirmation that is detected; and
adjusting the first model for the first premises according to the key performance indicator data.

9. The server of claim 1, wherein the configuration adjustment comprises a hardware change associated with the first element.

10. The server of claim 1, wherein the configuration adjustment comprises a software revision associated with first element.

11. The server of claim 1, wherein the historic cost of maintenance data comprises one of data associated with technician dispatches to the plurality of customer premises, data associated with inquiries to customer care facilities associated with the plurality of customer premises, or a combination thereof.

12. The server of claim 1, wherein the operations further comprise:
obtaining initial first key performance indicators associated with the communication services to the first customer premises of the plurality of customer premises; and
inputting the configuration adjustment of the first element and the initial first key performance indicators into the first model to generate predicted first key performance indicators, wherein the improvement in the first key performance indicators is determined according to a difference between the predicted first key performance indicators and the initial first key performance indicators.

13. The server of claim 1, wherein the operations further comprise determining a net improvement value for the configuration adjustment, wherein the net improvement value comprises the maintenance improvement value less the cost to configure value.

14. The server of claim 13, wherein the operations further comprise:
adding the configuration adjustment that is recommended to a plurality of proposed maintenance that are associated with the elements that provide the communication services to the plurality of customers;
arranging the plurality of proposed maintenance according to a plurality of net improvement values that are associated with the plurality of proposed maintenance to define an arranged plurality of proposed maintenance;
comparing the net improvement value for the configuration adjustment to the plurality of net improvement values of the arranged plurality of proposed maintenance; and
prioritizing the configuration adjustment within the arranged plurality of proposed maintenance according to the comparing of the net improvement value.

15. The server of claim 14, wherein operations further comprise presenting the plurality of net improvement values of the arranged plurality of proposed maintenance in a graphical representation that demonstrates cumulative net improvement values for the arranged plurality of proposed maintenance.

16. A machine-readable storage device, comprising executable instructions that, when executed by a processor, facilitate performance of operations, comprising:
applying linear regression to configuration data and key performance indicators that are associated with providing communication services to a plurality of customer premises via a network to generate a first model;
correlating the key performance indicators and customer lifetime data that are associated with the plurality of customer premises to determine a second model;
identifying, according to the first model, a configuration adjustment of a first element of the network for generating a quality improvement that is associated with a first customer premises of the plurality of customer premises;
calculating, according to the second model, a customer lifetime improvement according to the quality improvement, wherein the customer lifetime improvement is assigned a lifetime improvement value;
determining a configuration cost associated with the configuration adjustment of the first element, wherein the configuration cost is assigned a cost to configure value;
determining whether the lifetime improvement value exceeds the cost to configure value; and
directing a dispatch server to perform the configuration adjustment of the first element responsive to determining that the lifetime improvement value exceeds the cost to configure value.

17. The machine-readable storage device of claim 16, wherein the operations further comprise:
correlating the key performance indicators and maintenance services data that are associated with the providing of the communication services to determine a third model; and
calculating, according to the third model, a maintenance cost improvement according to the quality improvement, wherein the maintenance cost improvement is assigned a maintenance improvement value, and wherein the lifetime improvement value further comprises the maintenance improvement value.

18. The machine-readable storage device of claim 16, wherein the operations further comprise:
determining whether the configuration adjustment of the first element requires a dispatch of a technician, wherein the determining of the configuration cost comprises a dispatch cost if the configuration adjustment requires the dispatch of the technician; and
determining from the dispatch server whether a dispatch event has been previously scheduled for the first customer premises for a purpose other than the configuration adjustment, wherein the determining of the configuration cost does not comprise the dispatch cost if the dispatch event has been previously scheduled.

19. A method, comprising:
identifying, by a system comprising a processor according to a first model, a configuration adjustment for a first element of a network for providing communication services to a first customer premises, wherein the configuration adjustment generates a quality improvement that is associated with the first customer premises, wherein the first model comprises a linear regression of configuration data that is associated with providing the communication services to a plurality of customer premises and key performance indicators that are associated with the plurality of customer premises;
calculating, by the system according to a second model, a customer lifetime improvement according to the quality improvement, wherein the second model comprises a correlation of the key performance indicators and customer lifetime data that are associated with the plurality of customer premises, and wherein the customer lifetime improvement is assigned a lifetime improvement value;
determining, by the system, a configuration cost associated with the configuration adjustment of the first element, wherein the configuration cost is assigned a cost to configure value; and
directing, by the system, a dispatch server to perform the configuration adjustment of the first element responsive to determining that the lifetime improvement value exceeds the cost to configure value.

20. The method of claim 19, further comprising calculating, by the system according to a third model, a maintenance cost improvement according to the quality improvement, wherein the third model comprises a correlation of the key performance indicators and maintenance services data that are associated with the plurality of customer premises, wherein the maintenance cost improvement is assigned a maintenance improvement value, and wherein the lifetime improvement value further comprises the maintenance improvement value.
